(19) United States
(12) Patent Application Publication
(10) Pub. No.: US 2008/0316082 A1
(43) Pub. Date: Dec. 25, 2008

(54) Remote control system and method for providing application program thereof

(75) Inventor: Ching-Hwa Yang, Sansia Township (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/907,471

(22) Filed: Oct. 12, 2007

(30) Foreign Application Priority Data
Jun. 20, 2007 (TW) 096122196

(51) Int. Cl. G08C 19/12

(52) U.S. Cl. 341/176

(57) ABSTRACT

A remote control system including a remote controller and a computer system are provided. The computer system includes a remote control signal receiver, an image capturing device, a storage device and a processor. The remote controller outputs a remote control signal in response to a user's operation. When the remote controller is moved from steady state, the remote controller outputs the remote control signal as a motion detecting signal to the remote control signal receiver. The processor determines whether the remote control signal is a motion detecting signal. If the remote control signal is a motion detecting signal, the processor controls the image capturing device to capture an image of the user and stores the image into the storage device as a reference image and a set of personal setting data corresponding to the user's operation behavior. The processor loads the personal setting data for providing an application program accordingly.

This application claims the benefit of Taiwan application Serial No. 96122196, filed Jun. 20, 2007, the subject matter of which is incorporated herein by reference.

### BACKGROUND OF THE INVENTION

1. Field of the Invention

The invention relates in general to a remote control system, and more particularly to a remote control system capable of recognizing the user of the remote controller and providing an application program according to a personal setting data of the user.

2. Description of the Related Art

Conventional television is normally equipped with a remote controller for the user to remote control the television. However, if a user would like to select a favorite channel, the user has to remember the corresponding channel number or press the channel selection key disposed on the remote controller and browse the channel according to the channel number, and this is indeed very inconvenient to the user. Therefore, how to provide a remote control system adaptable to user's operation habits and preference has become an imminent goal to achieve.

### SUMMARY OF THE INVENTION

The invention is directed to a remote control system. The remote control system of the invention is capable of recognizing the user of the remote controller and storing a personal setting data for each user according to each user's behavior, habits and preference of operating various application programs. When a particular user would like to use various application programs, the computer system recognizes the user, and provides suitable setting of parameters and interfaces of the user on various application programs according to a stored personal setting data of the user, such that the user can conveniently operate the remote control system of the invention.

According to a first aspect of the present invention, a remote control system including a remote controller and a computer system is provided. The computer system includes a remote control signal receiver, an image capturing device, a storage device and a processor. The remote controller outputs a remote control signal in response to a user's operation. When the remote controller is moved from steady state, the remote controller outputs the remote control signal as a motion detecting signal to the remote control signal receiver. The processor determines whether the remote control signal is a motion detecting signal. If the remote control signal is a motion detecting signal, the processor controls the image capturing device to capture a captured image of the user and stores the captured image into the storage device as a reference image and a set of personal setting data corresponding to the user's operation behavior. The processor loads the personal setting data for providing an application program accordingly

According to a second aspect of the present invention, a method for providing an application program used in a computer system is provided. The method provides an application program in response to a remote control signal emitted by a user via a remote controller. The computer system includes a processor, an image capturing device and a storage device. The method includes the following steps. Firstly, the processor determines whether the remote control signal is a motion detecting signal, wherein the motion detecting signal is a remote control signal outputted when the remote controller is moved from steady state. Next, if the remote control signal is a motion detecting signal, the image capturing device captures a captured image of the user. Afterwards, the processor compares the captured image with a first reference image stored in a storage device. Then, if the captured image matches with the first reference image, then the processor loads a first set of personal setting data stored in the storage device and corresponding to the first reference image as a loaded personal setting data and provides an application program according to the loaded personal setting data.

The invention will become apparent from the following detailed description of the preferred but non-limiting embodiments. The following description is made with reference to the companying drawings.

### BRIEF DESCRIPTION OF THE DRAWINGS

FIG. 1 is a circuit diagram of a remote control system according to an embodiment of the invention;

FIG. 2A is a part of a flowchart of a method for providing an application program according to an embodiment of the invention; and

FIG. 2B is another part of a flowchart of a method for providing an application program according to an embodiment of the invention.

### DETAILED DESCRIPTION OF THE INVENTION

The remote control system of the invention is capable of recognizing the user operating the remote controller, and further storing the corresponding personal setting data of each user according to the user's behavior, habits and preference of operating various application programs. When a user would like to use various application programs, the computer system recognizes the user, and, according to the corresponding stored personal setting data of the user, provides operating interfaces and parameter settings of the application programs for the user's convenience of operation.

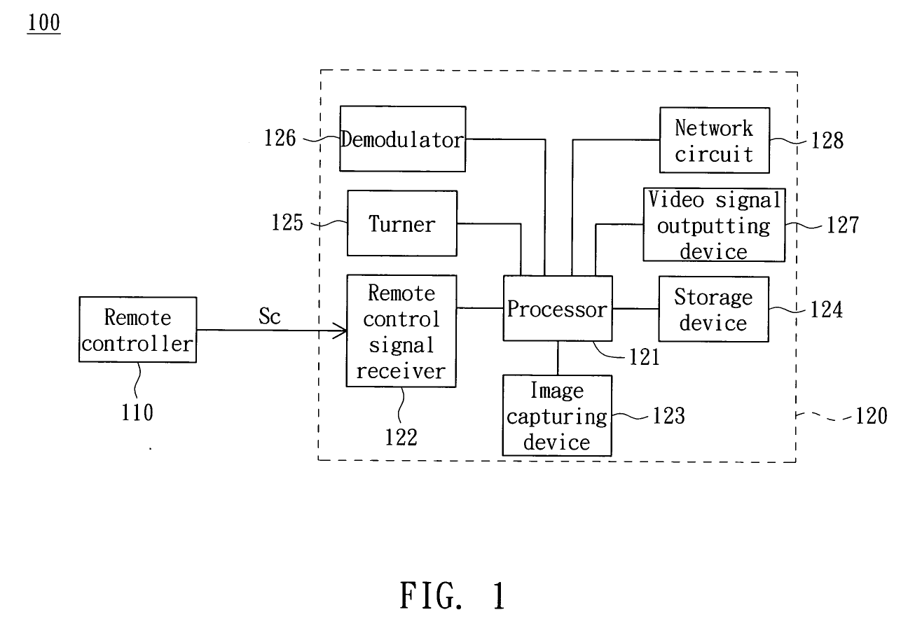

Referring to FIG. 1, a circuit diagram of a remote control system 100 according to an embodiment of the invention is shown. The remote control system 100 includes a remote controller 110 and a computer system 120. The computer system 120 includes a processor 121, a remote control signal receiver 122, an image capturing device 123 and a storage device 124.

In the present embodiment of the invention, the remote control system 100 records the reference images and the personal setting data of multiple users into the storage device 124. The storage device 124 is exemplified by storing a reference image Ir1 and a personal setting data S1 corresponding to the user U1, a reference image Ir2 and a personal setting data S2 corresponding to the user U2, and a reference image Ir3 and a personal setting data S3 corresponding to the user U3, and the remote control system 100 is exemplified by responding to the operation of the user Usr. The operation of the remote control system 100 is elaborated below.

When the user Usr would like to control the computer system 120 via the remote controller 110, firstly, the user Usr grabs the remote controller 110. When the remote controller 110 detects that itself is moved from steady state, the remote controller 110 outputs a remote control signal Sc as a motion detecting signal and transmits the motion detecting signal to the computer system 120.

After the remote control signal receiver 122 of the computer system 120 receives the remote control signal Sc, the processor 110 will decides the remote control signal Sc is a motion detecting signal. Then, the processor 110 controls the image capturing device 123 to capture a captured image Ic of the user Usr and further compares the captured image Ic with the reference image corresponding to the personal setting data Sload which is currently loaded for determining whether the current user Usr and the previous user who grabbed the remote controller 110 are the same one.

In the example, it is assumed the previous user is the user U1. When the remote controller 110 is grabbed by the user Usr, the personal setting data S1 of the user U1 has already loaded as the loaded personal setting data Sload at a previous time. Thus, when the remote controller 110 is grabbed, the processor 121 compares the captured image Ic of the user U1.

Usr with a reference image corresponding to the loaded personal setting data Sload. The reference image is currently the reference image Ir1 of the user U1.

If the captured image Ic matches with the reference image Ir1, then it is suggested that the current user Usr and the previous user U1 are the same one. The personal setting data of the user Usr is the personal setting data S1, and has already been loaded at a previous time as the loaded personal setting data Sload. The processor 121 keeps the loaded personal setting data Sload unchanged, and there is no need to create a new personal setting data or store the reference image corresponding to the user Usr.

In other words, if the comparison matches, then it is suggested that the user Usr already operated the remote controller 110 at a previous time. This implies that the current user Usr and the previous user of the remote controller 110 are the same one, and the corresponding personal setting data of the user Usr was already loaded at a previous time. Thus, the processor 121 only needs to provide an application program according to the loaded personal setting data Sload. When the remote controller 110 outputs the next remote control signal in response to the operation of the user Usr, the processor 121 performs the control instruction of the next remote control signal on the application program according to the loaded personal setting data Sload.

If the above comparison does not match, then it is suggested that the current user Usr and the previous user of the remote controller 110 are not the same one. Meanwhile, the processor 121 compares the captured image Ic of the user Usr with other reference images already stored in the storage device 124 such as the reference images Ir2 and Ir3. If the processor 121 matches the captured image Ic of the user Usr with a particular reference image, then it is suggested that the personal setting data of the user Usr is already stored in the storage device 124. The processor 121 loads the personal setting data corresponding to the matched reference image as the loaded personal setting data Sload for providing an application program accordingly.

For example, if the captured image Ic of the user Usr matches with the reference image Ir2, then it is suggested that the current user Usr and the user U2 are the same one. Meanwhile, the processor 121 loads the personal setting data S2 corresponding to the reference image Ir2 previously stored in the storage device 124 as the loaded personal setting data Sload.

If the captured image Ic of the user Usr does not match with any of the reference images stored in the storage device 124, then it is suggested that the user Usr is a new user whose personal setting data is not yet recorded. Meanwhile, the processor 121 stores the captured image Ic into the storage device 124 as a new reference image, for example, the reference image Ir4. The processor 121 further stores a set of personal setting data of the user Usr such like operation behavior, operation habits and preference as a personal setting data S4. The processor 121 loads the personal setting data S4 as the loaded personal setting data Sload for providing an application program accordingly.

In the present embodiment of the invention, after the processor 121 provides an application program according to the loaded personal setting data Sload and the remote controller 110 outputs a next remote control signal in response to the operation of the user Usr, the computer system 120 performs a control instruction of the next remote control signal on the application program according to the loaded personal setting data Sload.

In the present embodiment of the invention, if the remote control signal Sc is a motion detecting signal, it is suggested that the remote controller 110 is grabbed by the user Usr. Meanwhile, the processor 121 controls the image capturing device 123 to capture an image of the user Usr, and further compares the captured image with a reference image stored in the storage device 124. Thus, the processor 121 loads the personal setting data corresponding to the user Usr for providing an application program accordingly.

When the remote controller 110 is grabbed by the user Usr, a personal setting data applicable to the user Usr is loaded accordingly. Therefore, when the user Usr executes the application program via the remote controller 110, the application program is executed according to the user's preference and operation habits.

In the present embodiment of the invention, the remote control signal Sc can be one of a motion detecting signal, an application program enabling signal and an ordinary control signal. When the user Usr grabs the remote controller 110, the remote controller 110 outputs a motion detecting signal in response to the user's operation. When the user would like to enable a particular application program supported by the computer system 120, for example, a television application program or a browser program, the remote controller 110, in response to the operation of the user Usr, outputs a remote control signal Sc as a corresponding application program enabling signal of the application program. When the remote controller 110 controls a particular application program in response to the operation of the user Usr, for example, controls the channel selection of the television application program, the remote controller 110 outputs a remote control signal Sc as an ordinary control signal.

When the remote control signal receiver 122 receives the remote control signal Sc emitted by the remote controller 110, the processor 121 determines the category of the remote control signal Sc first. If the remote control signal Sc is a motion detecting signal, then the operation of the computer system 120 is the same as disclosed above and is not repeated here.

If the remote control signal Sc received by the remote control signal receiver 122 of the computer system 120 is an application program enabling signal, then the processor 121 enables the application program according to the current loaded personal setting data Sload. Thus, the setting of both the parameters and the interfaces of the application program is applicable to the user Usr.

If the remote control signal Sc received by the remote control signal receiver 122 is an ordinary control signal, then the processor 121, according to the current loaded personal setting data Sload, performs the corresponding control instruction of the ordinary control signal on the currently enabled application program. In the present embodiment of the invention, the processor 121 updates the personal setting data of the user Usr according to the operation of the ordinary control signal performed on the currently enabled application program, such that the user's preference, habits and behavior of operating the application program are updated accordingly in instantly.

Afterwards, any remote control signal Sc outputted by the remote controller 110 in response to the operation of the user Usr is processed according to the above procedure.

In the present embodiment of the invention, if the remote control signal receiver 122 does not receive any remote control signal over a period of time, the processor 121 disables the image capturing device 123 to save power. The image capturing device 123 is enabled by the processor 121 when the remote controller 110 is grabbed again.

In the present embodiment of the invention, the remote control signal Sc includes an identification code ID of the remote controller 110. After the processor 121 receives a remote control signal Sc, the processor 121 determines whether the identification code ID of the remote controller 110 matches with the identification code of the computer system 120 so as to determine whether the remote control signal Sc received by the computer system 120 is emitted by the corresponding remote controller 110. If the identification code ID of the remote controller 110 matches with the identification code of the computer system 120, it is suggested that the remote control signal Sc received by the computer system 120 is emitted by the remote controller 110, and the processor 110 starts to determine the category of the remote control signal Sc accordingly.

In the present embodiment of the invention, the remote controller 110 includes a movement detecting sensor, for example, an accelerometer or a gyrostat, for detecting whether the remote controller 110 is moved from steady state, and if the remote controller 110 is moved from steady state, the remote control signal Sc is outputted as a motion detecting signal.

In the present embodiment of the invention, examples of the application program provided by the computer system 120 include television application program, browser program for networking, and instant messenger (IM).

The present embodiment of the invention is exemplified by the operation of the remote control system 100 of when the user Usr would like to view the television. In the present embodiment of the invention, the computer system 120 further includes a tuner 125, a demodulator 126 and a video signal outputting device 127.

When the user Usr would like to view the television but the television application program is not executed yet, the remote controller 110, in response to the operation of the user Usr, outputs a remote control signal Sc as a corresponding application program enabling signal of the television application program to enable the television application program. The processor 110 provides a television application program according to the corresponding loaded personal setting data Sload of the user Usr. The loaded personal setting data Sload includes a parameter setting data of television application programs, such as the favorite channels of the user Usr at a particular time period. In the present embodiment of the invention, the favorite channels can be displayed in a selection menu sorted according to the frequency of selection. In the present embodiment of the invention, the selection menu is outputted and displayed on a displayer via the video signal outputting device 127.

When the user Usr would like to control the television application program, the remote controller 110 outputs a remote control signal Sc as an ordinary control signal in response to the operation of the user Usr. For example, when the user Usr selects a channel, the user Usr view the above selection menu first, and then outputs an ordinary control signal via the remote controller 110 to select the channel. The processor 110 controls the tuner 125 to select the channel according to the user ordinary control signal. The demodulator 126 decodes the television signal uploaded from the selected channel. Then, the video signal outputting device 127 converts the television signal into a video signal which is outputted to the displayer accordingly.

In the present embodiment of the invention, the processor 110 provides a selection menu according to the loaded personal setting data Sload for the user Usr to select a channel from. However, practical application is not limited to the application exemplified above. When the user Usr watches television by a television application program, the computer system 120 can further provide suitable parameter setting and interfaces according to the operation preference and operation habits of the user Usr.

The operation of the remote control system 100 of the present embodiment of the invention when the user Usr would like to access network is stated below. In the present embodiment of the invention, the computer system 120 further includes a network circuit 128. When the user would like to access network and the browser program is not yet performed, the remote controller 110 outputs a remote control signal Sc as a corresponding application program enabling signal of the browser program in response to the operation of the user Usr to enable the browser program. The processor 110 provides the browser program according to the corresponding loaded personal setting data Sload of the user Usr. The loaded personal setting data Sload includes a parameter setting data of browser program such as the favorite websites of the user Usr.

In the present embodiment of the invention, the application program is an instant messenger for example. When the user would like to have real-time communication but the instant messenger is not yet executed, the remote controller 110 outputs a remote control signal Sc as a corresponding application program enabling signal of the instant messenger to enable the instant messenger in response to the operation of the user Usr. The processor 110 provides the instant messenger according to the corresponding loaded personal setting data Sload of the user Usr. The loaded personal setting data Sload includes a parameter setting data of the instant messenger such as the account number of the contact person of the user Usr.

In the present embodiment of the invention, each user's personal setting data includes a boot parameter setting data. In the present embodiment of the invention, the boot parameter setting data corresponds to the application program which is executed when a user boots the computer system 120. For example, when a user boots the computer system 120, the to-be-executed application program is also the application program previously executed when the user previously operated the computer system 120.

The remote control system 100 of the invention embodiment recognizes the user by way of capturing an image of the user Usr and further loads suitable personal setting data for the user. Thus, the remote control system 100 provides an application program adapted to operation preference, operation habits and operation behavior of the user according to the loaded personal setting data.

In the present embodiment of the invention, examples of the application program include television application program, browser program and instant messenger. However, in practical application, the exemplification of the application program is not limited thereto. Any application programs that can be executed by the computer system 120 via the control of the remote controller 110 are within the scope of protection of the invention.

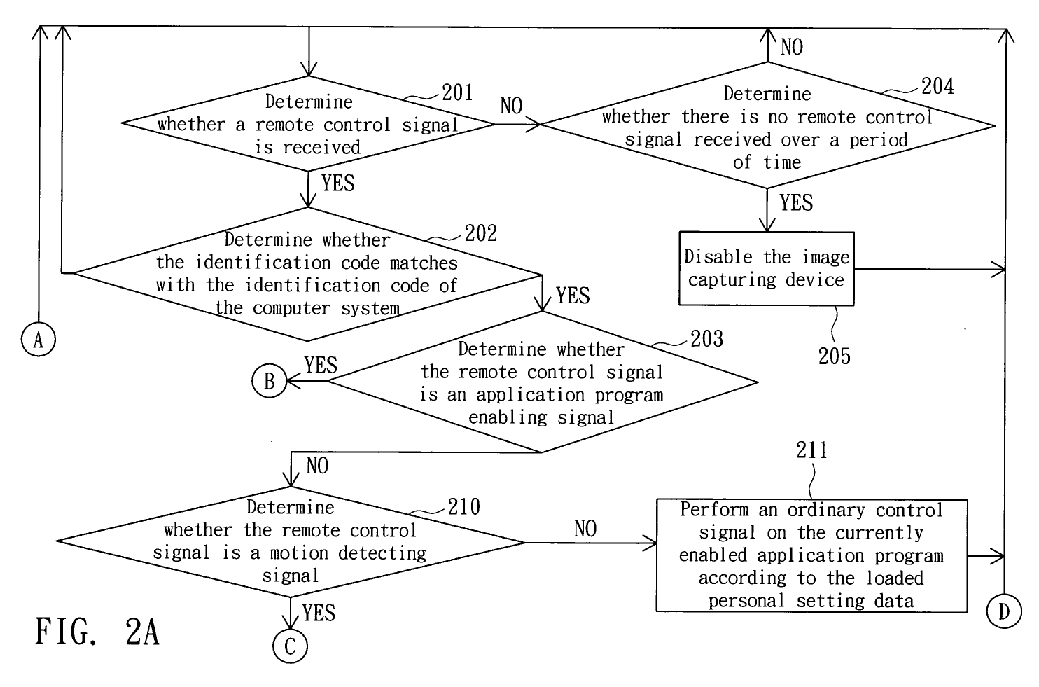

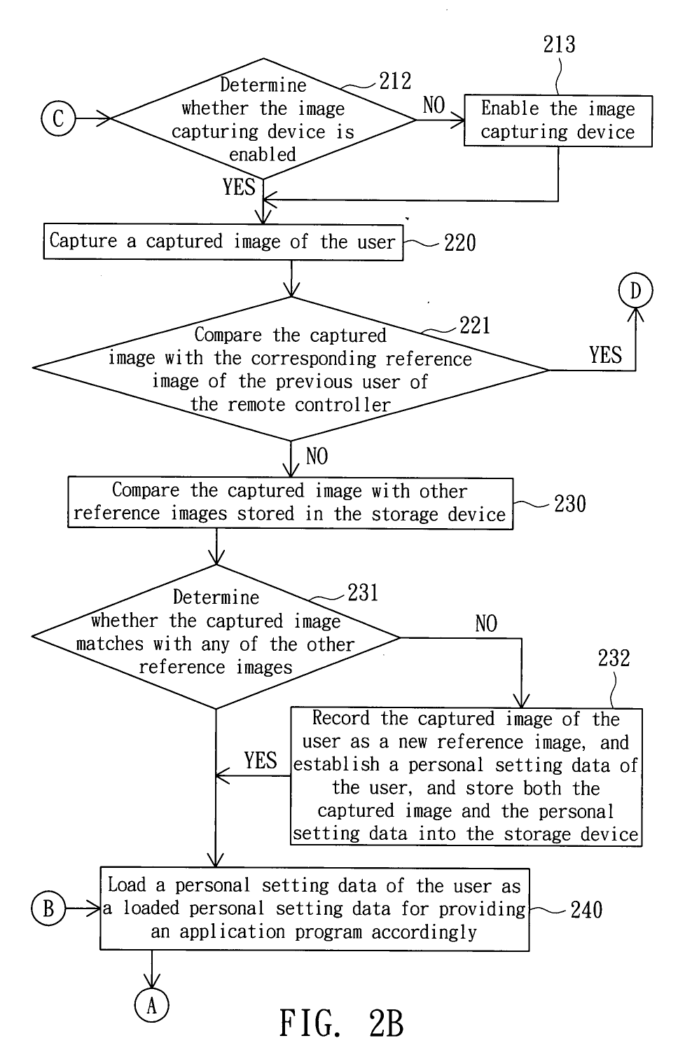

FIGS. 2A and 2B illustrate a flowchart of a method for providing an application program according to an embodiment of the invention. The method of the present embodiment of the invention is used in a computer system 120 for providing an application program in response to the remote control signal Sc outputted by the user Usr via the remote controller 110.

Referring to both FIG. 2A and FIG. 2B. The method begins at step 210, whether the remote control signal Sc is a motion detecting signal is determined by the processor 121. If the remote control signal Sc is determined as a motion detecting signal, then the method proceeds to step 220. In step 220, a captured image Ic of the user Usr is captured by the image capturing device 123. Afterwards, the method proceeds to step 230. In step 230, the captured image Ic is compared with other reference images stored in the storage device 121 by the processor 121 to determine whether the corresponding personal setting data of the user Usr is stored in the storage device 124.

If the captured image Ic matches with a particular reference image, then it is suggested that the user Usr is stored in the storage device 124, and the method proceeds to step 240. In step 240, a corresponding personal setting data of the user Usr is loaded by the processor 121 as a loaded personal setting data Sload for providing an application program accordingly.

Thus, the method for providing application program of the present embodiment of the invention provides an application program whose setting of parameters and interfaces are both suitable to the user Usr according to the corresponding personal setting data of the user Usr.

The detailed steps of the method for providing application program according to the present embodiment of the invention are elaborated below. Referring to both FIG. 2A and FIG. 2B. In step 201, whether a remote control signal Sc is received is determined by the remote control signal receiver 122 of the computer system 120. If so, the method proceeds to step 202. In step 202, whether the identification code ID of the remote control signal Sc matches with the identification code of the computer system 120 is determined by the processor 121. If so, it is suggested that the remote control signal Sc received by the computer system 120 is outputted from the corresponding remote controller 110, and the method proceeds to step 203 and step 210. In steps 203 and 210, whether the remote control signal Sc is an application program enabling signal, a motion detecting signal or an ordinary control signal is determined.

In step 203, whether the remote control signal Sc is an application program enabling signal is determined by the processor 121. If so, the method proceeds to step 240, otherwise the method proceeds to step 210. In step 240, the corresponding application program of the application program enabling signal is provided by the processor 121 according to the current loaded personal setting data Sload. In step 210, whether the remote control signal Sc is a motion detecting signal is determined by the processor 121.

If the remote control signal Sc is not one of a motion detecting signal and an application program enabling signal, it is suggested that the remote control signal Sc is an ordinary control signal, and the method proceeds to step 211. In step 211, the corresponding control instruction of the ordinary control signal is performed on the currently enabled application program by the processor 121 according to the current loaded personal setting data Sload. Afterwards, the method returns to step 201, a next remote control signal Sc is received by the remote control signal receiver 122.

If the remote control signal Sc is a motion detecting signal, then an image of the user Usr is captured by an image capturing device 123 for recognizing the user Usr and loading the corresponding personal setting data of the user Usr. Then, the method proceeds to step 212, whether the image capturing device 123 is enabled is determined by the processor 121. If the image capturing device 123 is not enabled, then the method proceeds to step 213, the image capturing device 123 is enabled by the processor 121.

After the image capturing device 123 is enabled, then the method proceeds to step 220, the image capturing device 123 is controlled by the processor 121 to capture the captured image Ic of the user Usr. Next, the method proceeds to step 221, the captured image Ic is compared with the corresponding reference image of the previous user of the remote controller 110 (that is, the reference image corresponding to the current loaded personal setting data Sload) by the processor 121 to determine whether the captured image Ic matches with the corresponding reference image of the previous user of the remote controller 110.

If the captured image Ic matches with the reference image, then the processor 121 keeps the loaded personal setting data Sload unchanged and provides an application program according to the loaded personal setting data Sload. Afterwards, the method returns to step 201, a next remote control signal Sc is received by the remote control signal receiver 122.

If the captured image Ic does not match with the reference image, then the method proceeds to step 230, the captured image Ic is compared with other reference images stored in the storage device 124 by the processor 121. Afterwards, the method proceeds to in step 231, whether the captured image Ic matches with any of the other reference images is determined by the processor 121. If so, the method proceeds to step 240, otherwise it is suggested that the user Usr has never used the remote control system 100, the method proceeds to step 232.

In step 232, the captured image Ic of the user Usr is stored as a new reference image, a personal setting data of the user Usr is established, and then both the captured image Ic and the personal setting data are stored into the storage device 124 by the processor 121. Afterwards, the method also proceeds to step 240, the personal setting data of the user Usr is loaded as a loaded personal setting data. Afterwards, the method returns to step 201, a next remote control signal Sc is received by the remote control signal receiver 122.

In step 201, when the remote control signal receiver 124 receives the remote control signal Sc, the method proceeds to step 204, whether not any remote control signal is received over a period of time is determined. If so, the method proceeds to step 205, the image capturing device 123 is disabled to save power, then the method returns to step 201, a next remote control signal Sc is received by the remote control signal receiver 122. If at least one remote control signal is received over a period of time, then the method returns to step 201 directly.

In the method for providing an application program of the present embodiment of the invention, whether the remote control signal Sc is an application program enabling signal is determined first. If the remote control signal Sc is not an application program enabling signal, then the remote control signal Sc is determined as a motion detecting signal. However, in practical application, the checking order is not limited thereto.

The remote control system of the embodiment of the invention recognizes the user according to an image of the user captured when the user grabs the remote controller loads a corresponding personal setting data of the user for providing various application programs accordingly. Therefore, the remote control system of the embodiment of the invention can set each application program according to each user's preference, habits and behavior of operating different application programs, such that the setting of parameters and interfaces of each application program meets each user's requirement.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A remote control system, comprising:
a remote controller for outputting a remote control signal in response to a user's operation, and when the remote controller is moved from steady state, the remote controller outputs the remote control signal as a motion detecting signal; and
a computer system, comprising:
a remote control signal receiver for receiving the remote control signal;
an image capturing device for capturing an image;
a storage device; and
a processor for determining whether the remote control signal is a motion detecting signal, if so, then the processor controls the image capturing device to capture a captured image of the user and stores the captured image as a first reference image into the storage device, the processor further stores a set of personal setting data corresponding to the user's operation behavior as a first set of personal setting data and loads the first personal setting data as a loaded personal setting data for providing an application program accordingly.

2. The remote control system according to claim 1, wherein after the processor provides the application program according to the loaded personal setting data, the processor performs a control instruction corresponding to the next remote control signal according to the loaded personal setting data when the remote signal receiver receives a next remote control signal.

3. The remote control system according to claim 1, wherein the storage device is for storing a second reference image and a second set of personal setting data corresponding to the second reference image, the second set of personal setting data is loaded at a previous time and used as the loaded personal setting data, the processor is for comparing the captured image with the second reference image, if the captured image matches with the second reference image, then the processor keeps the second set of personal setting data as the loaded personal setting data for providing the application program accordingly.

4. The remote control system according to claim 3, wherein if the captured image does not match with the second reference image, then the processor stores the captured image into the storage device as the first reference image, and stores the set of personal setting data corresponding to the user's operation behavior as the first set of personal setting data and loads the first set of personal setting data as the loaded personal setting data for providing the application program accordingly.

5. The remote control system according to claim 1, wherein the storage device is for storing a third reference image and a corresponding third set of personal setting data, and the processor is for comparing the captured image with the third reference image, if the captured image matches with the third reference image, then the processor loads the corresponding third set of personal setting data as the loaded personal setting data; otherwise, the processor stores the captured image into the storage device as the first reference image and stores the first set of personal setting data, and sets the first set of personal setting data as the loaded personal setting data.

6. The remote control system according to claim 1, wherein the processor is for determining whether the remote control signal is an application program enabling signal, if so, the processor enables the application program corresponding to the application program enabling signal according to the loaded personal setting data.

7. The remote control system according to claim 1, wherein the remote control signal further comprises an identification code of the remote controller, and after the processor receives the remote control signal, the processor further determines whether the identification code of the remote controller matches with the identification code of the computer system, if so, the processor determines the remote control signal as a motion detecting signal.

8. The remote control system according to claim 1, wherein the application program is a television application program, the first set of personal setting data comprises a parameter setting data of television application program, and the processor provides the television application program according to the parameter setting data of television application program.

9. The remote control system according to claim 8, wherein the computer system further comprises a tuner, a demodulator and a video signal outputting device, and if the remote control signal corresponds to a modulation control instruction, then the processor controls the tuner to select a channel according to the remote control signal, the demodulator is for demodulating the television signal transmitted from the selected channel, and the video signal outputting device is for converting the television signal into a video signal and further outputting the video signal to a displayer.

10. The remote control system according to claim 1, wherein the application program is a browser program, the first set of personal setting data comprises a parameter setting data of browser program, the computer system further comprises a network circuit, the processor provides the browser according to the parameter setting data of browser program, and the browser program accesses the network via the network circuit.

11. The remote control system according to claim 1, wherein the application program is an instant messenger, the first set of personal setting data comprises a parameter setting data of instant messenger, the computer system further comprises a network circuit, the processor provides the instant messenger according to the parameter setting data of instant messenger, and the instant messenger performs real-time communication via the network circuit.

12. The remote control system according to claim 1, wherein the remote controller further comprises a movement detecting sensor for detecting whether the remote controller is moved from steady state, if so, the remote controller outputs the remote control signal as the motion detecting signal.

13. A method for providing application program, used in a computer system for providing an application program in response to a remote control signal outputted via a remote controller by a user, the computer system comprises a processor, an image capturing device and a storage device, the method comprises the following steps:
determining, by the processor, whether the remote control signal is a motion detecting signal, wherein the motion detecting signal is the remote control signal outputted by the remote controller when the remote controller is moved from steady state;
capturing a captured image of the user by the image capturing device if the remote control signal is the motion detecting signal;
comparing, by the processor, the captured image with a first reference image stored in the storage device; and
loading, by the processor, a first set of personal setting data corresponding to the first reference image stored in the storage device as a loaded personal setting data for providing the application program accordingly if the captured image matches with the first reference image.

14. The method for providing application program according to claim 13, wherein after the step of loading the first set of personal data, the providing method further comprises the following step:
using the first set of personal setting data as the loaded personal data for receiving the next remote control signal.

15. The method for providing application program according to claim 13, wherein the storage device further stores a second reference image and a second set of personal setting data corresponding to the second reference image, the second set of personal setting data is loaded at a previous time and used as the loaded personal setting data, the method further comprises:
comparing the captured image with the second reference image by the processor, if the captured image matches with the second reference image, then the processor keeps the second set of personal setting data as the loaded personal setting data for providing the application program accordingly.

16. The method for providing application program according to claim 15, wherein if the captured image does not match with the second reference image, then the processor compares the captured image with a first reference image stored in a storage device.

17. The method for providing application program according to claim 13, further comprises the following step:
setting the captured image of the user and a set of personal setting data corresponding to the user's operation behavior as a third reference image and a third set of personal setting data, respectively, and storing the third reference image and the third set of personal setting data into the storage device by the processor, and loading the third personal setting data as the loaded personal setting data by the processor if the captured image does not match with any of the reference images stored in the storage device.

18. The method for providing application program according to claim 13, wherein the providing method further comprises the following step:
determining, by the processor, whether the remote control signal is an application program enabling signal, if so, then the processor, according to the loaded personal setting data, enables an application program corresponding to the application program enabling signal.

19. The method for providing application program according to claim 13, wherein the remote control signal further comprises an identification code of the remote controller, and after the step of receiving the remote control signal by the processor, the providing method further comprises the following step:
determining, by the processor, whether the identification code of the remote controller matches with the identification code of the computer system, if so, then the providing method proceeds to the step of determining the remote control signal is the motion detecting signal by the processor.

20. The method for providing application program according to claim 13, wherein the application program is a television application program, and the first set of personal setting data comprises a favorite channel of the user during a particular time period.
